(19) United States
(12) Patent Application Publication
(10) Pub. No.: US 2004/0216933 A1
(43) Pub. Date: Nov. 4, 2004

(54) A self-contained recreational electric vehicle that transports camping gear via semi-rough terrain to a walk-in camping facility

(76) Inventor: Jerry Lee Coale, Prineville, OR (US)

Correspondence Address: JERRY LEE COALE, 906 NW ROLLO LANE, PRINEVILLE, OR, 97754, US

(21) Appl. No.: 10/249,722

(22) Filed: May 3, 2003

(51) Int. Cl. B62D 51/04

(52) U.S. Cl. 180/19.1

(57) ABSTRACT

A self-contained recreational electric vehicle is provided for the transport of camping gear over groomed trails leading to a remote camping destination with primitive facilities, and for transporting gear and all refuse back to the trailhead. The vehicle is comprised of four wheels that are attached to a framework and body structure containing the vehicle motion control devices, an integrated system of camping apparatus and camping gear storage containers. The vehicle electric motors and electrical devices are powered by on-board batteries. Battery electrical charge is sustained by regenerative braking and photovoltaic panels. Computerized operator console and control electronics monitor and control the vehicle electrical drive, braking, steering and battery charging systems. The vehicle is theft and critter resistant, with lockable covers and a security system. The self-contained camping apparatus includes potable water facilities; portable toilet; refuse storage; perishable food storage; water heater; cook stove; lighting and storage for recreational camping gear. The vehicle operator uses a handle bar with pressure sensitive devices to control vehicle motion and direction. Vehicle forward speed cannot exceed a brisk but comfortable walking pace.

### BACKGROUND OF INVENTION

In recent years, there have been substantial advances in the field of electric vehicles. Many of these advances are due to technological improvements in electric battery design to improve their efficiency and to reduce their weight. Fuel cell device technology has also advanced to the point of making their commercial use both practical and safe. Consequently, there are many pure electric and hybrid electric specialized vehicles being designed to take advantage of these technological advances. This invention is another application of these advancing electric vehicle technologies towards creating a new machine that will serve the self-contained recreational camping vehicle market.

Electric vehicle concepts are also dependent on the use of materials that are lightweight, structurally strong and durable. Electric power consumption efficiency improves as vehicle weight is reduced. Technology advances in the field of composite materials have made many new products possible, including electric powered vehicles. This invention is also dependent on the use of composite materials and lightweight-high-strength metals to achieve an efficient and durable vehicle that will withstand the rigors of off-road recreational camping use.

The question is, is there a need for an electric powered self-contained camping vehicle that is only capable to transport camping gear, not personnel, and that does not travel faster than a person can walk, or is this just another “solution looking for a problem” type of idea? The answer is, there needs to be a need! This invention is not just about creating a new machine. It is also about creating a method that will help to address a very serious and growing problem. The problem has many facets, but the fundamental concern is “how to allow public access to environmentally sensitive public lands without sustaining irreparable damage to the natural environments”.

People need to recreate, and governments need to provide recreational facilities on public lands. Public demands for recreation are ever increasing, but so are the costs and problems that are caused to those who must service these demands. To be more specific, many people are not considerate of others or of the environment when they recreate. They cause damage to the land and don”t properly dispose of waste. Consequently, the people responsible to manage our public recreation lands are forced to restrict access and to spend large sums of money policing and supporting those areas where access is allowed. However, this approach is contentious and limited, as evidenced by frequent restricted access violations.

This invention does not purport to solve this problem. However, this invention does provide a tool for recreation land managers to use whereby people could be allowed to access remote camping facilities without incurring the problems of environmental damage and high support costs, if the camping facilities and their access trails are specifically designed for use with this invention. True, we already have extensive facilities for hiking and backpack camping. However, this type of activity is limited to a few strong individuals, and is certainly not well suited for families with small children, or for the elderly. Besides, these facilities do suffer damage because many people do not properly dispose of their waste or pack it out. Therefore, this invention would have recreation land managers construct trails and camping facilities that are specifically designed to accommodate the electric vehicle described by this specification, for the reasons listed below.

Public access to these facilities via automobile or equivalent type vehicles, including gasoline powered all-terrain-vehicles (ATVs) would not be permitted, thereby avoiding the costs and environmental damage resulting from this type of access.

Camping facilities designed for use with self-contained camping equipment are not required to provide extensive user support, considering that users are expected to pack in all supplies, including potable water, and are expected to pack out all refuse and waste.

These camping facilities could be used by families with small children, the elderly, and others who would not otherwise use hiking and backpacking facilities with a more difficult use factor.

### SUMMARY OF INVENTION

The object of this invention to provide a self-contained recreational camping vehicle that is capable to transport family camping gear to a remote walk-in type camping facility. It is a further objective that the vehicle will self-contain all necessary camping conveniences and supplies, and will store all refuse for return transport so that remote camping sites are not degraded by unauthorized waste disposal. By providing these objectives, the invention will enable people to participate in the type of camping experience that is currently limited to those who are capable to transport their camping gear in backpacks. This invention will also encourage governments to provide recreation camping facilities and access trails that are specifically designed for use with this invention, thereby allowing their park and recreation facilities to accommodate more users with reduced support requirements and with reduced impact to the natural environments.

To satisfy these objectives the invention provides a compact, efficient and reliable electric vehicle (EV) that is capable to transport and support all of the equipment necessary for recreational camping convenience. A bank of electric batteries provides the primary electrical power source for the EV embodiment that is described by this specification. Another possible embodiment would substitute fuel cell devices for some of the electric batteries. Fuel cell devices may be incorporated in the design as a means to reduce vehicle weight or as a means to extend the vehicle operational capability. Photovoltaic (PV) panels and drive motor regenerative breaking provide a means to replenish electric battery charge while the EV is in use. EV unit power supply and drive motor control is distributed to three identical electronic control modules. Failure of any one of the control modules or its associated devices will not significantly degrade EV unit operation. In travel mode, the EV unit is operated by a person who walks behind the vehicle and uses handle bar devices to control vehicle motion and direction. Maximum EV speed cannot exceed a brisk, but comfortable walking pace. The EV unit is reliable, safe to operate and will not harm the natural environments where it is used.

To further satisfy these objectives the invention integrates a respectable set of camping appliances, storage containers and utility functions into the EV package. The following list summarizes the self-contained camping facilities provided by the preferred embodiment of this invention. Other embodiments may alter the complement of facilities as a means to enhance user acceptance, or to reduce unit cost.

A system for potable water storage, input water purification, water distribution, and waste water recovery and storage;

A portable toilet and waste storage container;

A propane gas tank and propane gas distribution lines to a refrigerator, water heater, cook stove, and external appliance connection port;

A dc voltage power supply and distribution system to an on-demand water pump, refrigerator, periphery lighting, and external appliance connection port;

A refrigerator for perishable food storage that is powered by dc voltage when the EV is in transit, or powered by propane gas when the EV is setup to support camping activities;

A utility counter and work surface with integrated cook stove, water heater, water pump, water faucet and sink, water purification device, propane gas external appliance port, and an external dc electrical appliance connection port;

A secure container for solid refuse storage and transport;

Two covered storage compartments for camping gear and supplies;

Except for the propane gas and portable toilet compartments, all other user-access covers are lockable and protected by a security system with an audible intrusion alarm;

A set of cargo hooks to secure carry-on baggage.

A typical scenario for using this invention would start with EV unit batteries at full capacity. Electric power consumption required to propel an EV unit to a camping destination is partially reduced by regenerative braking and PV panel generated dc voltage. While at a camping site, PV panels continue to replenish battery charge, and the refrigeration unit is switched to operate from propane gas, which together may result in a net increase in battery charge level. Potentially, the batteries are restored to full charge before beginning the return trek or next leg of a journey.

While at a camping site, the potable water container may be replenished from local water that is processed through a filter and purification device. Fresh water used for food preparation and cleanup is stored by a gray water recovery container; the portable toilet stores black water and solid waste; and a secure container stores garbage and other refuse, all for transport to a proper waste disposal facility.

The objective of this invention is to enable its users to pack in all gear and supplies that are needed, to pack out all waste and refuse, and to leave minimal (if any) evidence of having used a recreational facility. Backpack type camping falls far short of being able to meet this same objective because it is inconvenient to properly dispose of waste and pack out refuse. The evidence of this assertion being the ever increasing problem of accumulated waste and the consequential environmental damage to public lands where remote camping is permitted.

### BRIEF DESCRIPTION OF DRAWINGS

FIG. 1 is a left front perspective view of the recreational electric vehicle in the travel mode.

FIG. 2 is a right rear perspective view of the vehicle undercarriage with access covers open and without components installed.

FIG. 3 is a left front perspective view of the vehicle undercarriage with access covers closed and without components installed.

FIG. 4 is a top perspective view of the vehicle undercarriage with battery and electric motor components installed.

FIG. 5 is a left rear perspective view of the vehicle undercarriage with the electrical control components installed.

FIG. 6 is a right front perspective view of the vehicle undercarriage with the fluid containers installed.

FIG. 7 is a left front perspective view of the vehicle undercarriage with service access covers installed.

FIG. 8 is a left front perspective view of the vehicle upper body without covers and camping components installed.

FIG. 9 is a left rear perspective view of the vehicle with camping components installed.

FIG. 10 is a left front perspective view of the vehicle with covers installed and open.

FIG. 11 is a right rear expanded perspective view of the vehicle handle bar with operator console attached.

FIG. 12 is a right rear perspective view of the vehicle in the self-contained recreational camping mode.

FIG. 13 is a left rear perspective view of the vehicle in storage or transport mode.

### DETAILED DESCRIPTION

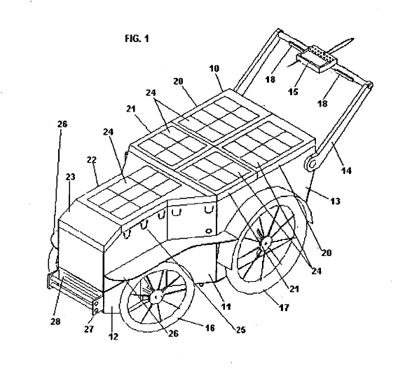

FIG. 1 shows a left front perspective view of a complete self-contained camping electric vehicle (EV) unit 10 that is setup for travel operation. Other figures will show the unit in a setup mode for stationary camping use, and in a setup mode for the unit to be transported by trailer or pickup truck. A completely assembled unit 10 comprises an integrated system of modular components according to the preferred embodiment of the invention. An undercarriage assembly 11, as will be described in further detail, comprises an enclosure that provides the structural foundation for the vehicle, houses the unit components that are heavy and do not require frequent access, also houses a portable toilet drawer assembly 12, and supports the vehicle upper body structure 13. The upper body structure 13, as will be described in further detail, comprises an enclosure that houses camping gear storage containers, camping appliances that require frequent access, and mounts the vehicle handle bar assembly 14. The handle bar assembly 14 is shown with the unit operator console 15 mounted for travel use. Other figures will show the operator console detached from the handle bar, as required for the unit camping and transport setups.

As shown in FIG. 1, the EV unit has two front wheels 16 that are steered by an electric motor that is located in the undercarriage enclosure. The unit also has two rear wheels 17 that are each driven by an electric motor that is located in the undercarriage enclosure. A unit operator applies pressure to the handle bar control pads 18 as a means to control vehicle motion and direction. The control pads 18, as will be described in further detail, initiate forward motion when a pushing pressure is detected, or initiate reverse motion or breaking action when a pulling pressure is detected. The vehicle steers left when the control pads 18 detect a right pivoting pressure, or the vehicle steers right when a left pivoting pressure is detected. The computerized operator console 15 transforms control pad signals into drive and steering motor control commands that it sends to motor controller modules that are located in the undercarriage enclosure. Unit mobility is enhanced by the independent motion, direction and breaking actions that may be applied to each rear wheel 17 so that an operator may apply a pivoting action as a mans to steer a unit through a tight corner. The intent for this invention is that vehicle movement only happens in response to operator commands, otherwise wheel brakes are engaged to prevent vehicle movement.

As shown in FIG. 1, user access to the EV unit storage containers and camping appliances is via six covers 20, 21, 22 and 23, that are shown in their closed position. Camping appliance access is via a pair of covers 20 that fold out to become a counter top for utility service. Two covers 21 provide user access to the perishable food storage compartment and to the refrigerator unit control switch. The cover 22 is hinged to open like the hood of an automobile and provide user access to a large container for camping gear storage. The cover 23 accesses a container that stores camping refuse for transport to an appropriate disposal facility. Five photovoltaic panels 24 are integrated into the covers 20, 21 and 22. The photovoltaic panels 24 generate dc voltage to recharge the bank of electric batteries that are located in the undercarriage 11. Each of the covers 20, 21, 22 and 23 can be locked and monitored by a vehicle security system as a means to prevent intrusion.

As shown in FIG. 1, sets of cargo hooks 25 on both sides of the unit are used to secure carryon baggage. The vehicle fenders 26 are strong enough to support carryon baggage and prevent conflict with the front wheels 16. A front bumper assembly 27 may be used to attach a mechanical winch device (not described in the specification). The bumper assembly 27 also attaches to an undercarriage cover 28 that may be unlatched to provide access to a drawer mounted portable toilet 12.

The remaining figures in this specification describe the EV unit 10 stages of assembly and illustrate the EV unit setup modes for travel, camping and vehicle transport. As will be described in more detail, the EV unit 10 is an integration of modular components that are housed and supported by a structurally strong vehicle enclosure. The EV structure design and use of materials is not the subject of this invention. The EV modular components are all derived from commercial sources and are not the subject of this invention. This invention is about the systems integration of commonly available components in a fashion that provides a unique function. The detail description of this invention concerns the assembly and integration of modular components so that the unique function becomes feasible and practical.

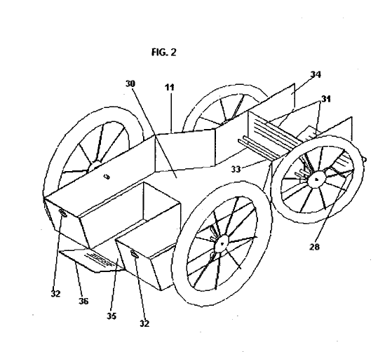

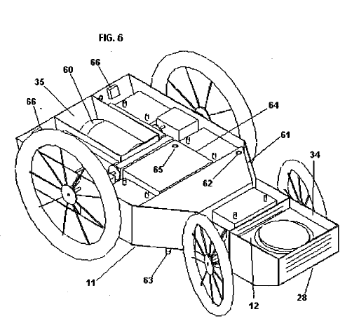

FIG. 2 is a left rear perspective view of the EV unit undercarriage 11 showing the moisture resistant enclosure 30 that will house batteries, electric motors and electronic controller assemblies. The enclosure 30 is ventilated by input airflow louvers 31 and by exhaust air louvers 32. A pair of temperature activated air movement devices (refer to FIG. 6) will be installed as a means to force ventilation airflow when necessary. Smoke and propane gas detection devices (not shown in the figure) may be installed in the enclosure 30 to protect the EV unit and its users. The enclosure 30 is designed to remain dry as a means to protect the EV unit electrical components, however a drain port 33 is provided in case fluid needs to be removed from the enclosure.

As shown in FIG. 2, the front portion of the undercarriage 11 provides an accessible compartment 34 where a drawer mounted portable toilet 12 will be installed. The compartment access cover 28 is shown in the open position.

FIG. 2 also shows that the rear portion of the undercarriage provides an isolated compartment 35 where a propane gas tank will be mounted. The compartment access cover 36 is ventilated and cannot be locked, allowing for emergency access if necessary.

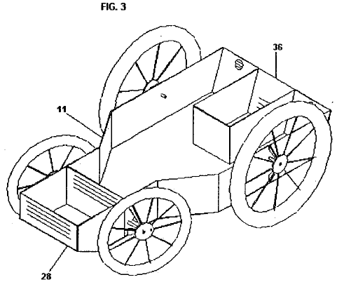

FIG. 3 is a left front perspective view of the EV unit undercarriage 11 showing the compartment access covers 36 and 28 in their closed position.

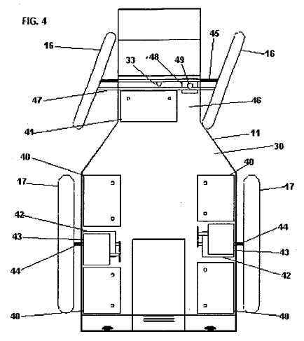

FIG. 4 is a top view of the EV unit undercarriage 11 showing enclosure component locations. The electric batteries 40 and 41 are placed in the undercarriage enclosure 30 so that their weight is distributed for optimal unit stability. The two electric drive motors 42 and two electrically controlled transmission units 43 are mounted in the enclosure so that the drive shafts 44 connecting each transmission unit to a rear wheel 17 is minimal in length. The front wheels 16 attach to a front axel assembly 45. The front axel assembly 45 may attach to an electric motor (not shown in the figure) as a means to provide an optional front wheel drive capability for the EV unit. The enclosure space 46 is reserved for an optional front wheel drive motor and related hardware. Front wheel steering is provided by a control shaft 47 that is moved left or right by an electric steering motor assembly 48. A mechanical cranking device may be inserted in the steering motor drive shaft 49 as a means to manually control EV unit steering.

Another embodiment of this invention would replace the four electric batteries 40 with two fuel cell devices, one fuel cell device supplying electric power to each of the two drive motors 41 and their associated electrical and electronic components.

Also shown in FIG. 4 is the enclosure 30 drain port 33.

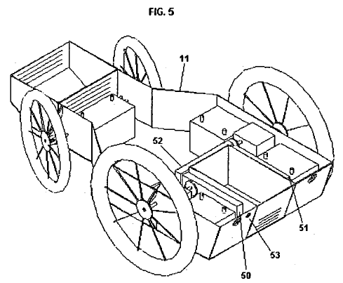

FIG. 5 is a left rear perspective view of the EV unit undercarriage 11 showing the electronic control modules and their locations. The functions provided by these modules are a part of this specification. The design and packaging of these modules is not specific to the invention. The electronic control modules 50, 51 and 52 are identical components that provide battery power management, and motor control functions. The module 50, located on the left side of the enclosure is wired to manage the left rear wheel drive components and batteries. The module 51, located on the right side of the enclosure is wired to manage the right rear wheel drive components and batteries. The module 52, located in the center of the enclosure is wired to manage the front wheel steering motor, optional front wheel drive components, and the battery that is located adjacent to the front axel. Each of the modules 50, 51 and 52 provide the following functions:

Monitor and maintain battery electrical charge, using regenerative breaking and photovoltaic panel generated dc voltage as the electrical charge source.

An AC to dc voltage converter that applies a fast charge to batteries if an external AC voltage is supplied via the connector 53.

Conditionally supply dc voltage to a fuse panel (not shown in FIG. 5) that distributes voltage to the unit camping appliances and to an external appliance connector port. Circuitry will disable this dc voltage supply if battery charge is below a threshold, or if the batteries are being charged from an external AC voltage source.

Interface with the EV unit operator console 15 (not shown in FIG. 5) to receive status requests. A status request returns battery and drive motor status information. A control command affects motor direction and speed. The interface is implemented using standard computer I/O device methods and technology that are not described by this specification.

Interface with the EV unit operator console 115 (not shown in FIG. 5) to receive control commands. Control command parameters affect drive motor direction and speed; select a transmission gear ratio; and, activate and deactivate an electric wheel-brake mechanism.

Detect and isolate a defective battery from the power distribution system.

Automatically disable the drive motor and deactivate an electric wheel-brake (not described by this specification) if a serious fault condition is detected. The electric wheel-brake may be disabled by the user.

FIG. 6 is a right front perspective view of the EV unit undercarriage 11 showing a propane gas tank 60; potable water storage container 61; gray water recovery container 64; and, portable toilet 12.

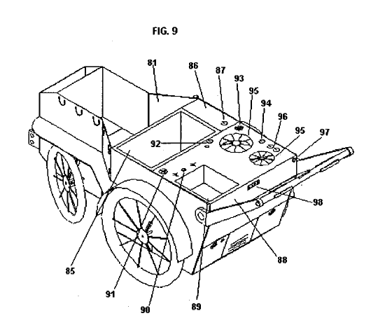

A propane gas tank 60 is mounted in a ventilated and accessible undercarriage compartment 35. A user is required to disconnect and remove the tank from the compartment before refilling the tank. A user is required to turn off propane gas distribution while the EV unit is in travel or transport mode. When the EV unit is in camping mode the propane tank 60 distributes propane gas (distribution lines not shown) to a cook stove, water heater, refrigerator and external appliance port (shown in FIG. 9).

Two temperature activated air movement devices 66 are installed over louvered openings at the rear of the enclosure to exhaust air that has been heated by the enclosure electrical components.

A potable water storage container 61 is permanently installed in the undercarriage enclosure 30. The container may be filled directly via a pipe that will attach to the container fill port 62. If potable water is not available, a water filter and purification device 91 (shown in FIG. 9) provides an alternate means to refill the container. A drain valve 63 is used to remove unused water from the container 61.

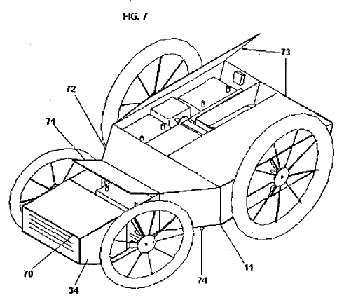

A gray water recovery container 64 is permanently installed in the undercarriage enclosure 30. A utility sink drain (not shown in FIG. 6) connects to the container fill port 65. The gray water container drain valve is shown in FIG. 7. A user is expected to recover all excess and used potable water via the utility sink for transport back to an approved disposal facility.

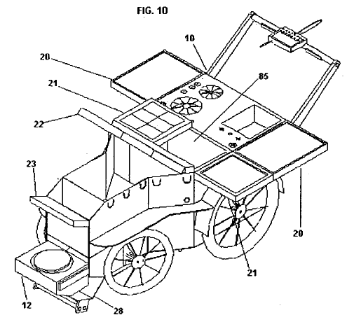

A removable portable toilet and waste storage container 12 is installed in the undercarriage front access compartment 34. The portable toilet assembly mounts on a set of fully extendable drawer slides (not shown in FIG. 6). When the compartment cover 28 is opened, the toilet assembly slides out for use (refer to FIG. 10) or for removal. A user is expected to transport toilet waste to an approved disposal facility.

FIG. 7 is a left front perspective view of the undercarriage 111 with the service access covers installed. A fixed cover 70 isolates the portable toilet compartment 34 from the upper body storage compartments. A removable cover 71 provides service access to the front wheel steering components and battery. A fixed cover 72 isolates the potable water container from the upper body storage compartment. Two removable covers 73 provide service access to the rear wheel drive components and batteries. Cover ports for routing the undercarriage plumbing and wiring are not shown. FIG. 7 also shows the drain valve 74 for the gray water recovery container.

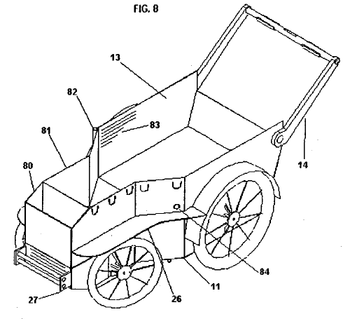

FIG. 8 is a left front perspective view of the combined undercarriage 11 and upper body structure 13 with the vehicle fenders 26, front bumper 27, and handle bar 14 assemblies installed. The manufacturing method that is used to combine the undercarriage and upper body structural components is not described by this specification. Different embodiments of the invention could construct these two components from a single mold, or from two half-molds.

Also shown in FIG. 8 are the refuse storage compartment 80 and the unit utility compartment 81. Subsequent figures will show utility component and compartment cover installations. A stanchion 82 that will be used to attach and support a lamppost is attached to the right side of the upper body. A set of louvers 83 provides ventilation for the refrigerator power unit that will be shown in FIG. 9. A capped pipe assembly 84 provides an external fill port for the potable water storage container. A lockable cap or cover device may be implemented as a means to prevent unauthorized access to the fill port.

FIG. 9 is a left rear perspective view of the upper body utility compartment 81 with utility components installed. A refrigerator appliance 85 slides into the utility compartment, but may be removed if service access to the undercarriage compartment is necessary. The refrigerator appliance 85 includes a refrigeration power unit 86 with an operational mode and temperature control switch 87. The refrigeration unit is powered either by dc voltage or by propane gas, although only the propane gas mode allows for the colder temperature settings. The user is expected to operate the refrigeration unit in propane gas mode only when the EV unit is setup for camping mode. The refrigeration unit may be turned off when it is not in use or when necessary to conserve EV power.

FIG. 9 also shows the utility service counter assembly 88 that contains several camping appliances and user convenience functions, as listed below. The specific complement of appliance features and their service counter locations may vary with other embodiments of this invention. The service counter assembly 88 may be removed if service access to the undercarriage compartment is necessary.

A utility sink 89 is integrated into the service counter. The sink drain port (not visible in FIG. 9) is connected to the gray water recovery container.

A hot and cold water faucet assembly 90 is integrated into the service counter. The user attaches a flexible hose and hand held water-dispensing device (not shown in FIG. 9) to the faucet port when the EV unit is setup for camping mode. Hot and cold flow control valves activate an on-demand water pump device (not shown in FIG. 9) that is located inside the service counter assembly. Cold water is pumped directly from the potable water storage container. Hot water is pumped from a water heater appliance 93 that is located inside the service counter assembly.

A water filter and purification device 91 is integrated into the service counter. Water that is processed through the filter and purification device is input to the potable water storage container. This device is used to replenish the potable water supply when a reliable potable water source is not available. A user is expected to replace the purification cartridge when necessary.

Propane gas is distributed to service counter appliances, including an external appliance connection port and control valve assembly 92. This connection port allows a user to connect optional user supplied propane gas appliances, such as a lantern or cooking device. A service counter cover 20 activated interlock switch (not shown in FIG. 9) disables propane gas distribution to service counter appliances when the cover is in the closed position.

A propane gas powered water heater appliance 93 is integrated into the service counter. The water heater control switch 94 uses staged switch settings to activate the on-demand water pump, activate the water heater, and enter a water temperature threshold setting. Water heater operation requires the water pump to be turned on.

A propane gas powered two burner cook stove 95 and control valve 96 appliance are integrated into the service counter.

Dc voltage is distributed to service counter appliances, including an external appliance connection port 97. This connection port allows a user to attach optional user supplied dc voltage appliances, such as an entertainment or communications device.

Security system circuitries (not shown in FIG. 9) and a security keypad 98 are integrated into the service counter assembly. The security system provides the following user functions:

Local or remote activation and deactivation of cover locks

Local or remote activation and deactivation of an intrusion audible alarm

Local or remote activation of a panic alarm

A backup method to enable EV unit drive and steering motor operation

A backup method to control EV unit drive motors and steering motor

FIG. 10 is a left front perspective view of the complete EV unit 10 showing the user access covers in open positions. The two utility service counter covers 20 fold out to expand the service counter work surface. Either refrigerator unit cover 21 may be opened to provide access to the perishable food storage compartment 85. The camping gear storage compartment cover 22 is held in its open position by a friction device (not shown in FIG. 10) that allows safe and hands-free access to the compartment. The refuse container cover 23 self-latches and self-seals when closed as a means to minimize odor detection and prevent critter access. The portable toilet compartment access cover 28 is shown in the open position with the portable toilet 12 in the drawer extended position. In their closed position, all user access covers seal-in odor and seal-out moisture.

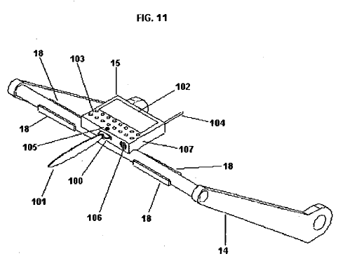

FIG. 11 is an expanded right rear perspective view of the operator console 15, shown attached to the handle bar 14. The operator console 15 is a custom assembly of standard electronic components, operating system software, and application software. It provides several user functions, as will be described further, however its primary function is to enable and control EV unit travel operations. For this purpose, the console must be attached physically and electrically to the handle bar 14, as shown in FIG. 11. This electrical connection interfaces the console to the handle bar control pads 18, and to the three battery and drive motor control modules 50, 51 and 52 (refer to FIG. 5).

EV unit operation is enabled when the operator console 15 is attached to the handle bar 14 and a security key 100 containing a valid access code is inserted in the console. The security key must remain inserted during EV unit travel operation. EV unit drive motors are disabled and wheel-brakes are engaged if the security key is removed. As a safety precaution, the user is expected to attach the security key tether 101 to his or her person so that EV unit operation is disabled if the operator should loose control of the unit.

While EV unit operation is enabled, control functions that are programmed into the console 15 transform signals received from the pressure sensitive control pads 18 into drive motor speed and direction commands. Console functions periodically transform control pad signals and send a control command sequence so that the electric motor controllers are continually receiving updated control information. An operator may use either the right or left hand set of control pads 18, or both sets to manipulate EV unit motion and direction. A pushing pressure results in forward movement. A pulling pressure will halt forward movement, or initiate reverse movement. A right-pivoting pressure will cause the unit to steer left. A left-pivoting pressure will cause the unit to steer right. A combined pushing, pulling and pivoting pressure results in a pivoting action, as might be required to steer an EV unit through a tight corner. Maximum EV unit speed cannot exceed a brisk but comfortable walking pace, and unit speed is reduced when turning, or when moving to the reverse direction. The intent of this invention is to provide a machine that is both safe and easy to operate when traveling over semi-rough terrain.

As shown in FIG. 11, the operator console assembly 15 includes an LCD type display 102, a function keypad 103, an antenna 104, microphone 105, speaker 106, and a wireless communications link 107 to the EV unit security system 98 (refer to FIG. 9). These device characteristics enable the console to provide the user functions listed below, some of which are optional features.

A function key initiated display of battery status and power usage statistics.

Function keys activate and deactivate EV unit security system functions:

Cover locks

Intrusion alarm

Panic alarm

An integrated Global Position Sensing (GPS) device provides the following capabilities:

Compass position relative to true north

Elevation relative to sea level

Temperature and barometric pressure

Trail map and guided directions to and from a target destination

Emergency position locator

An integrated cellular type telephone or VHF radio for emergency and non-emergency communications.

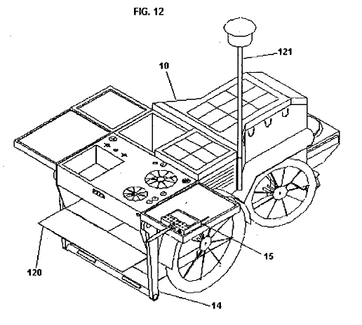

FIG. 12 is a right rear perspective view of EV unit 10 as setup for camping mode. The handle bar 14 is rotated to its transport position so that it does not hinder user access to the service counter camping appliances. The operator console 15 has been detached from the handle bar. This disables the EV unit monitor and control functions, but the other remote communication functions remain operational.

As shown in FIG. 12, the rear utility storage compartment cover 120 is open for convenient user access to camping gear and supplies. The figure also shows the camping lamppost 121 installed in its support stanchion and dc voltage connection.

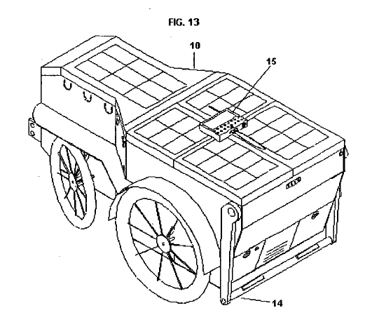

FIG. 13 is a left rear perspective view of the EV unit 10 as setup for transport mode. All access covers are closed, and as with the camping mode, the operator console 15 is detached and the handle bar 14 is rotated to its down position. The EV unit dimensions and gross weight parameters are expected to allow a fully loaded unit to be transported by a light duty pickup truck, or on a light duty utility trailer.

1. An electric powered four wheel vehicle for off-road use providing a means to house a configuration of self-contained camping appliances, and providing further means to transport recreational camping gear and supplies between a trailhead and a remote camping facility, the electric powered vehicle comprising:
an undercarriage enclosure providing the means to attach and support said vehicle wheel assemblies, including the two independently mounted rear wheels and the two axel mounted front wheels;
the undercarriage enclosure comprising a multitude of electrical components providing the means for said vehicle operation and control;
the undercarriage enclosure comprising a plurality of fluid containers providing functional support for said vehicle self-contained camping appliances;
the undercarriage enclosure providing a means to attach and support an upper body enclosure;
the upper body enclosure comprising a compartment for refuse storage, a compartment for camping gear storage, a compartment for camping supply storage, a refrigeration unit and container for perishable food storage, and a service counter module further comprised of a plurality of electric and propane gas powered camping appliance and convenience items;
a plurality of upper body compartment cover assemblies comprising a means to prevent unauthorized access to compartment contents, and further comprising a means to seal in odors and seal out moisture;
a handle bar assembly that is securely attached to the upper body compartment and disposed to the rear of said vehicle, and comprising a means for said vehicle to be operated by a person who grasps the handle bar and walks with the vehicle while it is in motion.

2. The upper body compartment cover assemblies of claim 1 that provide a means to access the camping gear storage compartment, the refrigeration unit, and the service counter, each cover assembly further comprising a photovoltaic panel that is integrated into the upper surface of each cover assembly thereby providing a power source for claims 10 and 16.

3. The handle bar assembly of claim 1 further comprising four electrical devices that provide a means to transform operator applied pressure into electrical signals that indicate pressure direction and amplit ude.

4. The handle bar assembly of claim 1 further comprising a computerized operator console that receives electrical signals from the electrical devices of claim 3, and periodically transforms the signals into a control command sequence that is electrically transmitted to the electronic control components of claims 12 and 17 thereby providing a means to control said vehicle motion and direction.

5. The computerized operator console of claim 4 further comprising a coded security key function providing a means to disable said vehicle operations if said security key is unintentionally removed while the said vehicle is in motion, further providing a means to prevent unauthorized use of said vehicle.

6. The undercarriage enclosure of claim 1 further comprising two symmetrical electrical component configurations that are disposed to outer rear enclosure locations and providing a means to apply forward and reverse drive motion to said vehicle right and left rear wheels respectively.

7. For each electrical component configuration of claim 6 further comprising at least two electric batteries, an electronic control module, an electric motor with regenerative breaking capability, an electrically activated transmission and drive shaft assembly, and an electrically deactivated rear wheel brake assembly.

8. For each electrical component configuration of claim 6 further comprising a means to replace the two electric batteries in each configuration with a fuel cell device, thereby providing the means to reduce said vehicle weight and to extend said vehicle operational parameters.

9. The electronic control modules of claim 7 further comprising a means to charge the electric batteries of claim 7, using an AC voltage source that is external to said vehicle.

10. The electronic control modules of claim 7 further comprising a means to charge the electric batteries of claim 7, using the photovoltaic panels of claim 2 as the charging power source.

11. The electronic control modules of claim 7 further comprising a means to charge the electric batteries of claim 7, using the electric drive motor regenerative braking of claim 7 as the charging power source.

12. The electronic control modules of claim 7 further comprising a means to receive electrically transmitted commands from the operator console of claim 4, further comprising a means to transform the received commands into electrical signals that control the components of claim 7.

13. The undercarriage enclosure of claim 1 further comprising an electrical component configuration that is disposed to the center front enclosure location and providing a means to steer said vehicle right and left front wheels.

14. The electrical component configuration of claim 13 further comprising at least one electric battery, an electronic control module, an electric motor that is attached to a front wheel steering mechanism, and two electrically deactivated front wheel brake assemblies.

15. The electronic control module of claim 14 further comprising a means to charge the electric battery of claim 14, using an AC voltage source that is external to said vehicle.

16. The electronic control module of claim 14 further comprising a means to charge the electric battery of claim 14, using the photovoltaic panels of claim 2 as the charging power source.

17. The electronic control module of claim 14 further comprising a means to receive electrically transmitted commands from the operator console of claim 4, further comprising a means to transform the received commands into electrical signals that control the components of claim 14.

18. The electrical component configuration of claim 13 further comprising a means to include a front wheel drive motor as a said vehicle feature option.

19. The undercarriage enclosure of claim 1 further comprising a set of ventilation louvers and a plurality of temperature activated air movement devices, thereby providing a means to avoid electrical component damage due to overheating.

20. The undercarriage enclosure of claim 1 further comprising an isolated compartment that is disposed to a centered forward enclosure location and containing a removable portable toilet unit, further comprising a ventilated cover providing unrestricted access to the compartment.

21. The undercarriage enclosure of claim 1 further comprising a container for potable water storage, further comprising the means to fill and drain the container.

22. The undercarriage enclosure of claim 1 further comprising a container for gray water storage, further comprising a means to fill and drain the container.

23. The undercarriage enclosure of claim 1 further comprising an isolated compartment that is disposed to a centered rear enclosure location and containing a removable propane gas container, further comprising a ventilated cover providing unrestricted access to said compartment.

24. The handle bar assembly of claim 1 further comprising a means for rotating the handle bar to an out-of-the-way position, thereby allowing unrestricted user access to the storage compartment and service counter appliances that are disposed to the rear of said vehicle.

25. The said vehicle of claim 1 further comprising predetermined dimension and weight parameters such that an incident of the said vehicle with full payload capacity may be transported by a standard light duty pickup truck.
